(19) United States
(12) Patent Application Publication
(10) Pub. No.: US 2010/0100326 A1
(43) Pub. Date: Apr. 22, 2010

(54) VIEWING DEVICE FOR AIRCRAFT COMPRISING AUDIBLE ALARM MEANS REPRESENTING AIRCRAFT PRESENTING A RISK OF COLLISION

(75) Inventors: Christian Nouvel, Merignac (FR); Corinne Bacabara, La Haillan (FR); Jean-Noel Perbet, Eysines (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/540,920

(22) Filed: Aug. 13, 2009

(30) Foreign Application Priority Data
Sep. 9, 2008 (FR) 08 04950

(51) Int. Cl. G08G 1/16

(52) U.S. Cl. 701/301

(57) ABSTRACT

The general field of the invention is that of synthetic vision type viewing systems SVS, for a first aircraft, said system comprising at least position sensors of said aircraft, an air traffic detection system calculating the position and the dangerousness of at least one second aircraft presenting a risk of collision with said first aircraft based on data obtained from recognition sensors, an electronic computer, a human-machine interface means and a display screen, the computer comprising means of processing different information obtained from the sensors and from the interface means. The system according to the invention also comprises a frequency synthesizer coupled to at least one loudspeaker, arranged so that, when the second aircraft is at a distance from the first aircraft that is less than a safety distance, the synthesizer generates an audible alarm representative of at least one of the parameters of said second aircraft. Furthermore, the display screen comprises a symbology representative of the operation or of the state of the frequency synthesizer.

### RELATED APPLICATIONS

The present application is based on, and claims priority from, French Application Number 08 04950, filed Sep. 9, 2008, the disclosure of which is hereby incorporated by reference herein in its entirety.

### BACKGROUND OF THE INVENTION

1. Field of the Invention

The general field of the invention is that of anti-collision systems for aircraft and more particularly that of the presentation of anti-collision information.

2. Description of the Prior Art

For an aircraft in flight, it is vital to know very accurately the aircraft that are situated in its immediate environment in order to avoid any risk of collision. This problem is particularly crucial in a certain number of applications where the aircraft are required to fly at low altitude with reduced visibility conditions. Historically, since the years 1960-1970, a solution that is independent of Air Traffic Control has gradually emerged. This solution is known by the acronym TCAS, standing for “Traffic alert and Collision Avoidance System”.

Today, a number of TCAS families coexist:
The first generation, called TCAS I supplies only “Traffic Advisory” (TA) type alerts to the proximity of intruders, moving vehicles presenting a risk to the aircraft such as another aeroplane, etc. It is primarily used in general aviation, that is in the light aircraft domain.
TCAS II supplies TA-type alerts to the proximity of intruders and also conflict resolution by suggesting avoidance manoeuvres to the pilot. The operating mode is called RA, standing for “Resolution Advisory”. These avoidance manoeuvres are performed in a vertical plane by a climb or a descent. It is primarily used in commercial aviation. TCAS II was made mandatory in the 1990's on all airliners.
TCAS III, still in development, is an improvement on TCAS II enabling in addition a resolution of the conflicts (RA) in the horizontal plane by left or right turn manoeuvres.

The presentation of the information to the pilot is now well known. As an example, FIG. 1 shows the presentation of intruders on an ND (Navigation Display) type screen. The intruders are presented in a 2D horizontal plane relative to the aircraft 100 in so-called “ROSE” mode, alluding to the French word for compass. The aircraft 100 occupies the centre of the “ROSE” 101 represented by a graduated circle. The shape and the colour of the intruders differ according to their associated degree of danger and according to the TCAS operating mode.

As examples, the aircraft 102 is close, at a relative altitude of 1100 feet under the aircraft 100, the relative altitude being symbolized by the indication “−11”. This aircraft is climbing, symbolized by an up-pointing arrow in FIG. 1. It is represented by a solid diamond coloured white or cyan representing a threat in PT (Proximate Traffic) mode. According to the aeronautical conventions, when the diamond is solid, the threat is of PT type, if it is empty, then the threat is of OT type, meaning “Other Traffic”.

The aircraft 103 is a threat in RA “Resolution Advisory” mode. It is situated at a relative altitude of 100 feet under the aircraft 100 and climbing. The colour of the square that represents it is red.

The aircraft 104 is an intruder in TA “Traffic Advisory” mode, it is 900 feet above the aircraft 100 and descending. The colour of the circle that represents it is amber.

As can be seen, the interpretation of the information by the pilot is far from immediate, which can prove particularly dangerous in cases of imminent risk of collision.

The new Synthetic Vision Systems SVS currently give the pilots a synthetic representation of the outside world and therefore, a better awareness of the surrounding dangers such as collisions with the ground without loss of control, commonly called CFIT (Controlled Flight Into Terrain). These SVS systems can currently display in 3D a synthetic terrain and the natural or artificial obstacles (buildings, etc.). An improvement on the presentation of the information supplied by the TCAS has been proposed in the Honeywell patent application entitled “Perspective View Conformal Traffic Target Display”, published under the international number WO2007/002917A1. FIG. 2 shows an example of representation of the intruders on a screen 200 of PFD (Primary Flight Display) type according to the provisions of this patent application. The intruders are presented in 3D in a conformal manner, that is, positioned in their real placement in the landscape. Additional information is associated with the intruders to assist the pilot in locating their position, above or below a reference altitude and their degree of separation obtained through a variation of the size of the symbols. FIG. 2 shows, in a 3D conformal synthetic view of the terrain 201, the air traffic. This view also includes a representation 210 of the PFD information. Intruders are presented in the sector in front of the aeroplane. The intruders 204 and 205 are represented by squares that are larger or smaller depending on their relative distance to the aeroplane. Other symbols are added to assist the pilot in interpreting the relative altitude of the intruder relative to the aeroplane. Thus, the symbols 202 and 203 representative of the vertical masts give the position and the height of the intruders above the ground. This presentation is well suited to airliners which fly relatively at high altitude.

Although the new SVS systems give the pilot a better understanding of the situation of the intruders, in particular their type, their positioning, their behaviour, their performance, and so on, these new systems are inadequate for carrying out missions at low altitude. In practice, intruders are very rare for airliners flying on instruments, which follow pre-established flight plans in strict air corridors and are controlled by air traffic organizations using radars. However, helicopters or small aeroplanes can fly in large numbers at low altitude, for example, to assist in a rescue of a large number of victims, in the context of a “red” plan or in the context of civil accident prevention missions.

In this case, the flight is essentially a visual flight, with no established flight plan and/or outside conventional radar coverage. The visibility conditions can be degraded if flying at night, if flying towards the sun, in the presence of smoke for fire missions, and so on. The aircraft also have more dynamic and more varied trajectories (turns, climbs, descents, etc.) than those of airliners. Given these conditions, it is particularly important for the pilot to understand as intuitively as possible the degree of dangerousness of the intruders.

### SUMMARY OF THE INVENTION

The aim of the invention is to use, in parallel with the conventional presentation of the intruders on onboard viewing screens, audible alarms representative of the intruders and the hazards that they represent, some of these alarms appearing on the viewing screens so as to make the pilot as aware as possible of the potential danger represented by the intruder.

More specifically, the subject of the invention is a synthetic vision type viewing system SVS, for a first aircraft, said system comprising at least position sensors of said aircraft, an air traffic detection system calculating the position and the dangerousness of at least one second aircraft presenting a risk of collision with said first aircraft based on data obtained from recognition sensors, an electronic computer, a human-machine interface means and a display screen, the computer comprising means of processing different information obtained from the sensors and from the interface means, characterized in that the system also comprises a frequency synthesizer coupled to at least one loudspeaker, arranged so that, when the second aircraft is at a distance from the first aircraft that is less than a safety distance, the synthesizer generates an audible alarm representative of at least one of the parameters of said second aircraft.

Advantageously, the parameter of the second aircraft is the type, the category, the size or the relative speed of the second aircraft or a sound that is characteristic of said aircraft. Furthermore, when the parameter is the relative speed of the second aircraft, the frequency of the audible alarm is modulated so as to simulate a Doppler effect.

Advantageously, the display screen comprises a symbology representative of the operation or of the state of the frequency synthesizer. Furthermore, when the screen displays a two-dimensional or three-dimensional representation of the space surrounding the first aircraft, the spatial boundaries between which an alarm is likely to be emitted are represented in a conformal view.

Finally, when a number of second aircraft present a risk of collision with the first aircraft, the computer comprises means for determining the second aircraft presenting the highest danger, the audible alarm being representative of said second aircraft.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a first presentation of the TCAS-type information according to the prior art;

FIG. 2 represents a second presentation of the TCAS-type information according to the prior art;

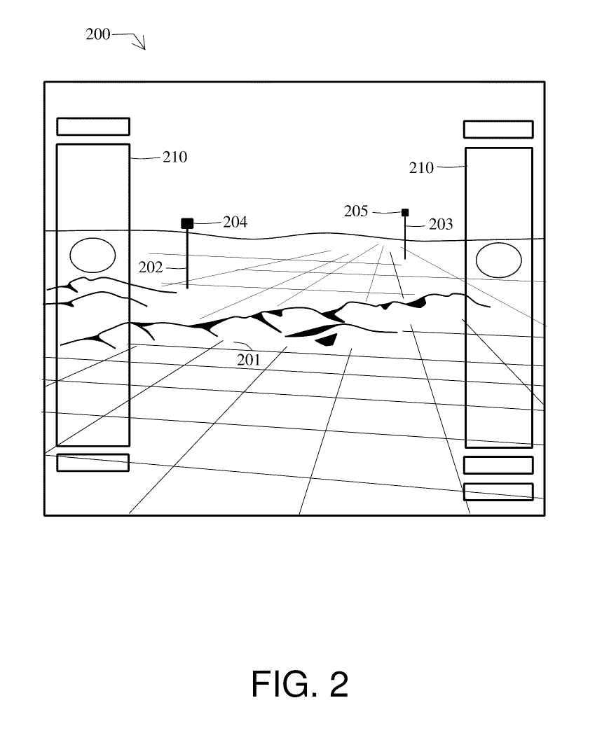

FIG. 3 represents the diagram of a viewing system according to the invention;

FIG. 4 represents an overview of a TCAS-type display according to the invention.

### MORE DETAILED DESCRIPTION

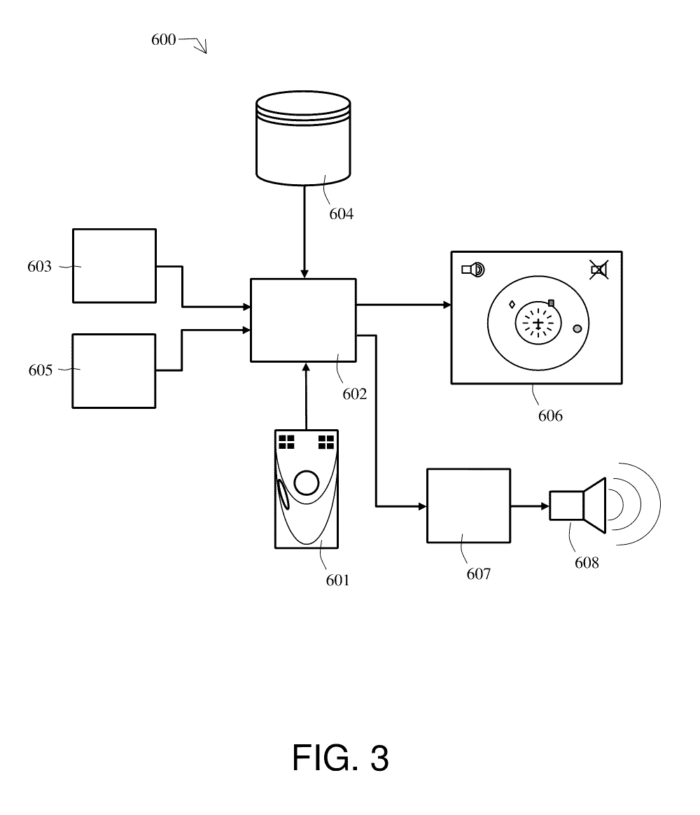

FIG. 3 represents an exemplary architecture of the system, the subject of the invention, mounted on a first aircraft. The other aircraft situated in the space close to this first aircraft will be called hereinafter in the description intruding aircraft or more simply intruders.

This exemplary graphic display system 600 includes a processor 602 configured to supply the screen 606 with the information to be displayed. One or more data sources are linked to the processor 602. These data sources include a terrain database 604 used for plotting the perspective view, positioning sensors 603 of the aeroplane, air traffic detection systems, intrusion detectors 605, a frequency synthesizer 607 coupled to at least one loudspeaker 608, and control means 601 for the presentation of the information to the pilot.

The databases are generally positioned in the aircraft. The data can also originate from the ground by transmission or “data link” means. Furthermore, these data can be stored on different peripheral devices such as diskettes, hard disks, CD-ROMs, volatile memories, non-volatile memories, RAMs or other means that can be used to store data.

The display system also comprises human-machine interface and control means 601. These means are, for example, as represented in FIG. 3, conventional control stations, control being applied by the use of knobs, touch surfaces, etc. or CCDs (Cursor Control Devices), means similar to a computer “mouse”.

The processor 602 is interfaced with hardware components that provide a graphic rendition. For example, these hardware components are one or more microprocessors, memories, storage appliances, interface cards or any other standard components. In addition, the processor 602 works with software or firmware. It is capable of reading machine instructions to perform various tasks, computations and control functions and generate the signals to be displayed and the other data used by the display screen. These instructions can be stored on diskettes, hard disks, CD-ROMs, volatile memories, non-volatile memories, RAMs or any other means that can be used to store data. All these means are known to those skilled in the art.

The processor 602 supplies the data to be displayed to the display screens 606. These data comprise at least:
The position in latitude/longitude, the speed, the heading, etc. of the aircraft based on the current location of the aircraft obtained from the position sensors 603;
The relative positions of the intruders supplied by the air traffic detection system 605;
Where appropriate, information originating from the terrain databases 604.

The processor 602 is configured to receive and calculate the aeroplane data, namely the current location of the aircraft obtained from the position sensors 603 which can be an inertial unit, a GPS-type system, etc.

The traffic detection systems 605 comprise at least one TCAS system. They can also be systems of the ADS-B (Automatic Dependent Surveillance Broadcast) or TIS-B (Traffic Information Service Broadcast) type, or a “Traffic Computer” which merge the data obtained from the TCAS or the ADS-B. Optionally, the data can be supplied by a digital link of Datalink type. These traffic systems can supply the position of the intruders, the types of the intruders (helicopters, aeroplanes, other), their speed, etc.

The processor 602 is configured to receive the information, check its consistency, and also store historically, for example, the last positions of each intruder and predict the future trajectory over a short period. The number of values logged is parameterizable.

The intruders that are visible in the forward sector can be presented in a 3D conformal view on a piloting screen of PFD (Primary Flight Display) type or in a two-dimensional or three-dimensional view on a piloting screen of ND (Navigation Display) type.

Furthermore, the system comprises a frequency synthesizer 607 coupled to at least one loudspeaker 608, subjects of the inventions and arranged so that, when an intruder is at a distance from the first aircraft that is less than a safety distance, the synthesizer generates an audible alarm representative of at least one of the parameters of said second aircraft.

When an intruder approaches the aircraft within a period of the order of 30 seconds, the processor calculates the limit frequencies of the sound emitted by the alarm, the variation law and the tone of the sound. The pilot can thus easily recognize and differentiate a helicopter, a small or a large aeroplane, etc. Thus, when the aircraft is a helicopter, the audible alarm will reproduce the noise of the rotating blades. This audible signal depends in a non-exhaustive way on the type of the intruder, its size, its speed, its manoeuvring capabilities.

The frequency synthesizer 607 is switched on and the sound volume on the loudspeakers 608 is adjusted by user selection from the control panel 601. The loudspeakers 608 are either arranged in the cockpit, or incorporated in a headset if the sound environment of the cockpit is too noisy.

The adjustment of the value of the minimum and maximum frequencies to simulate the sound effect and the methods of calculating the frequency increments which can be linear or non-linear laws are also done by user selection from the control panel 601.

The audible alarm can also be a succession of audible beeps, the time between which varies with the speed of the moving vehicle relative to the aircraft or even have a frequency that ranges towards high-pitch for intruders approaching the aircraft, or towards low-pitch for objects moving away, so as to imitate the Doppler effect of a moving vehicle.

In the case where several intruders are within the field of the aircraft, a logic is used to determine the one that presents the highest danger, and thus to select the intruder requiring a priority multi-mode alarm.

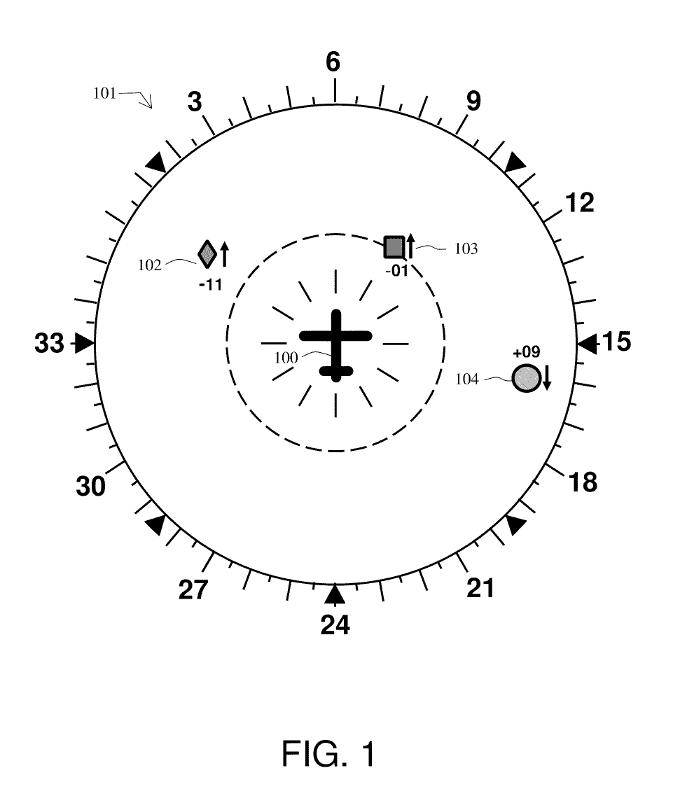

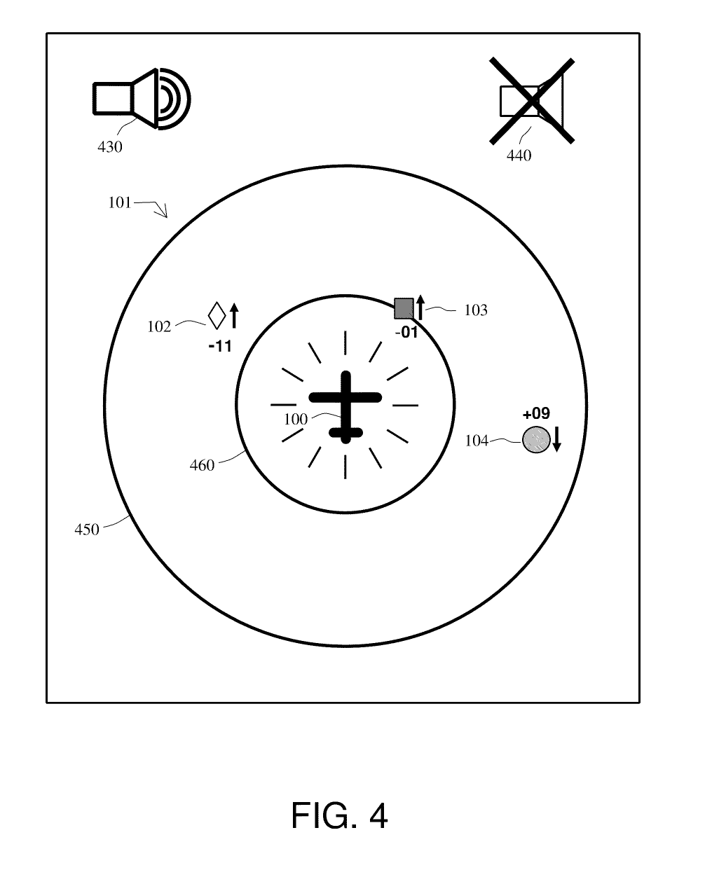

There is an interest in coupling the audible alarms with visual indications presented on the viewing screens. Thus, FIG. 4 represents intruders on an ND (Navigation Display) type screen. The intruders are presented in a 2D horizontal plane relative to the aircraft 100 in “ROSE” mode in a representation equivalent to that of FIG. 1.

FIG. 4 also comprises new symbols representative of the audible alarms and that are represented by bold lines. Thus, the symbols 430 and 440 that represent a loudspeaker that is on or off indicate the possible operation of the sounds supplied by the frequency synthesizer. The circles 450 and 460 indicate the limits of the variation of the frequency of the sound.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. Synthetic vision type viewing system SVS, for a first aircraft, said system comprising at least position sensors of said aircraft, an air traffic detection system calculating the position and the dangerousness of at least one second aircraft presenting a risk of collision with said first aircraft based on data obtained from recognition sensors, an electronic computer, a human-machine interface means and a display screen, the computer comprising means of processing different information obtained from the sensors and from the interface means, the system also comprising a frequency synthesizer coupled to at least one loudspeaker, arranged so that, when the second aircraft is at a distance from the first aircraft that is less than a safety distance, the synthesizer generates an audible alarm representative of at least one of the parameters of said second aircraft.

2. The viewing system according to claim 1, wherein the parameter of the second aircraft is either the type, the category or the size of the second aircraft or a sound that is characteristic of said aircraft.

3. The viewing system according to claim 1, wherein the parameter of the second aircraft is the relative speed of the second aircraft.

4. The viewing system according to claim 3, wherein, when the parameter is the relative speed of the second aircraft, the frequency of the audible alarm is modulated so as to simulate a Doppler effect.

5. The viewing system according to claim 1, wherein the display screen comprises a symbology representative of the operation or of the state of the frequency synthesizer.

6. The viewing system according to claim 5, wherein, when the screen displays a two-dimensional or three-dimensional representation of the space surrounding the first aircraft, the spatial boundaries between which an alarm is likely to be emitted are represented in a conformal view.

7. The viewing system according to claim 1, wherein, if several second aircraft present a risk of collision with the first aircraft, the computer comprises means for determining the second aircraft presenting the highest danger, the audible alarm being representative of said second aircraft.
